(19) United States
(12) Patent Application Publication
(10) Pub. No.: US 2005/0246249 A1
(43) Pub. Date: Nov. 3, 2005

(54) Method for predicting design requirements for wireless networks

(75) Inventor: Joseph J. Bardwell, Danville, CA (US)

Correspondence Address: ROSENFELD LAW CORPORATION, 2165 FILBERT STREET, SUITE 200, SAN FRANCISCO, CA, 94123, US

(73) Assignee: Connect802 Corporation, Danville, CA (US)

(21) Appl. No.: 10/909,002

(22) Filed: Jul. 28, 2004

Related U.S. Application Data
(60) Provisional application No. 60/563,156, filed on Apr. 16, 2004.

(51) Int. Cl. G06F 17/60

(52) U.S. Cl. 705/29

(57) ABSTRACT

Disclosed are methods for determining a bill-of-materials for wireless networks based either on a selected target sales market or current inventory of wireless equipment. The methods involve defining a set of useful equipment features; defining feature groups which are subsets of the set of equipment features; obtaining representative location information describing construction characteristics of locations for the wireless network; defining location categories, where each of the location categories is representative of locations with similar construction characteristics based on the representative location information; and determining the wireless equipment to be included in a bill-of-materials for constructing the wireless communications network for the location categories based upon the similar construction characteristics and the feature group.

### FIELD OF THE INVENTION

This present invention generally relates to engineering and management systems for the design of wireless communications networks and, more particularly, to a method for determining wireless equipment requirements for wireless networks based either on a selected target sales market or current inventory of wireless equipment.

### BACKGROUND OF THE INVENTION

With the increase in consumer demand for wireless network connectivity the ability of equipment providers and design engineers to quickly and accurately satisfy customer purchase requirements has become a significant competitive differentiator. Companies are frequently asked to provide price quotations for wireless network systems after being provided with only limited information about the characteristics of the proposed installation location. These companies face two significant challenges. First, they must accurately determine the quantity, and type, of wireless base stations and antennas that must be used to provide appropriate signal coverage. Second, they must then be prepared to deliver the specified equipment to their customer in a way that is both cost effective for the customer and profitable for the company.

Accurate equipment specification and effective control of the supply chain are critical to meeting both consumer goals and the business goals of the equipment provider. The equipment provider must have a way to accomplish this that is easy for non-technical sales representatives to apply in a manner that is systematic, and reproducible.

Presently, there are computer software design tools on the market that can be used for specifying the equipment necessary to implement a wireless network, assuring adequate coverage and cost effective equipment selection. LAN Planner™ software from Wireless Valley, Inc. (disclosed in U.S. Pat. No. 6,493,679 entitled “Method and System For Managing A Real Time Bill Of Materials” issued to Rappaport et al., assigned to Wireless Valley Communications, Inc., and herein incorporated by reference), RingMaster™ from Trapeze Networks, Inc., and Positioning Engine from Ekahau, Inc. are examples of these design tools. In practice, however, these tools require significant skill and advanced training to use effectively. They require that a skilled design engineer input assumptions about the proposed installation location and only an engineer, not a sales representative or other person not having advanced training, can make these assumptions. Moreover, these tools cannot be used to provide immediate price quotations to consumers since they all require that a model be created with which the radio transmission characteristics of a proposed installation location can be determined. Even a skilled user of these tools will require at least one hour, and as many as six hours, to create a design of a consumer's location. This results in delays and frustration for the consumer, and the need for the equipment provider to pay for the services of a skilled design engineer just to create a price quote, which may, or may not, be accepted by the consumer. Moreover, using software design tools to specify the equipment needed for a particular site does nothing to help the equipment provider anticipate the inventory levels necessary to meet future needs since they will not know what a particular bill-of-materials will contain until after they have designed a network.

Current art in this area of wireless network implementation is always based either on equipment bundles packaged on a “best guess” basis, or on site-specific design at the time a quotation is prepared for installation. Vendors and manufacturers currently have no method by which they can predict the equipment requirements for a particular market segment and must base their inventory levels and manufacturing levels on generalized sales forecasts instead of on statistical assessment and computer modeling.

Currently, to package in-stock equipment into the most potentially desirable, saleable packages, vendors have to hope that sales representatives would sell the in-stock product and often vendors resorted to heavy discounting to reduce inventory that was in stock for extended periods. In every case, excess stock, or in-stock equipment, is discounted or otherwise associated with a sales incentive when it is deemed appropriate to reduce the inventory level of an item and, further, sales people are normally instructed as to what items should be suggested during a sales proposal.

Consumers, who are often decision makers in business organizations contemplating the purchase of wireless network equipment, do not have the technical training or experience to design wireless networks with an assurance of proper signal coverage. They often resort to a “best guess” process in which they purchase some equipment, install it, and see what happens. If there are areas of their location that do not receive proper signal coverage they purchase additional wireless networking equipment in an attempt to rectify the problem. Because these decision makers are not wireless networking engineers they are unable to use the design tools that are available to a skilled design engineer. Consequently, if the decision maker wants to assure proper signal coverage, they have no choice but to pay for expensive consulting services through which an engineer creates a design for a wireless network at the proposed installation site. Consumers need a way to quickly and easily select the correct equipment for the implementation of a wireless network without requiring the consumer to become highly educated in the art of wireless network design and without forcing them to pay for expensive consulting services.

### SUMMARY OF THE INVENTION

Accordingly, the present invention provides a method for planning wireless communication networks based on the most probable models of indoor or outdoor installation sites thereby predicting both the most probable models as well as the equipment inventory required to implement those models. To attain this, one embodiment of the invention follows these steps:
a. typical construction characteristics associated with indoor or outdoor sites used by members of a selected target sales market are obtained from readily available sources
b. wireless network features that may be desired by members of the target sales market are identified and a limited set of feature groups are defined
c. representative computer models are created to simulate a limited set of representative sites based on the typical construction characteristics
d. a trained engineer uses design tools to determine the equipment required to provide correct signal coverage for the representative sites based on the requirements of each feature group
e. decision makers are provided with a set of purchase options based on the feature groups and the typical construction characteristics found in locations used by the target sales market

Accordingly, it is an object of the present invention to provide a method of planning a wireless communication network based on the most probable models of indoor or outdoor installations thereby predicting the most probable sales opportunities and also predicting the wireless network equipment inventory necessary to fill the aforesaid sales opportunities thus facilitating the sales and marketing of wireless networking equipment. The management of the supply chain is also facilitated through the ability to anticipate future inventory requirements without actually knowing the specifics of any particular potential installation site. Further, it is an object of the present invention to allow the creation of a simple set of purchase options that can be easily, and accurately, selected by a consumer who is not skilled in the art of wireless network design.

Another object of the present invention is a method for planning a wireless communication network on the basis of a set of arbitrary equipment components thereby allowing a manufacturer, or other equipment vendor, to accurately determine the characteristics of sites, and therefore the potential sales market, into which equipment is available for the installation of a properly designed wireless communication network. In this way, the manufacturer or equipment vendor can recognize the possible sales opportunities afforded by stock on hand, and can adjust inventory levels through the supply chain to maintain sufficient equipment to meet anticipated needs.

It will be obvious to one skilled in the art that the invention may be applied in ways other than the preferred embodiments to predict construction categories, feature groups, target markets, and use of available or procurable inventory.

### BRIEF DESCRIPTION OF THE DRAWINGS

FIG. 1 is a flowchart depicting the method of the first preferred embodiment.

FIG. 2 shows a publicly accessible web page on the U.S. Department of Energy web site for use in the methods described in FIGS. 1 and 11.

FIG. 3 shows a publicly accessible interactive web form on the U.S. Census Bureau web site for use in the methods described in FIGS. 1 and 11.

FIG. 4 shows a table from a publicly accessible web site (tpub.com) by Integrated Publishing of Spring, Tex. for use in the methods described in FIGS. 1 and 11.

FIG. 5 shows a page from a report publicly accessible on the State of Florida Department of Management Services' web site (smsisdmz02.state.fl.us) for use in the methods described in FIGS. 1 and 11.

FIG. 6 shows a table in a report publicly accessible on a web page at the U.S. Department of Energy web site for use in the methods described in FIGS. 1 and 11.

FIG. 7 shows a screen image taken from the RF design software program titled, “LAN Planner” from Wireless Valley, Inc., Austin Tex. for use in the methods described in FIGS. 1 and 11.

FIG. 8 shows a publicly accessible web page on the National Oceanic and Atmospheric Administration Boulder, Colo. office web site displaying a photograph for use in the methods described in FIGS. 1 and 11.

FIG. 9 is a page from a U.S. Census Bureau report for use in the methods described in FIGS. 1 and 11.

FIG. 10 depicts three stages of development of an RF simulation.

FIG. 11 is a flowchart depicting the method of the second preferred embodiment.

### DETAILED DESCRIPTION OF THE PREFERRED EMBODIMENTS

The methods of the invention provide process for specifying equipment requirements for wireless network installations and for providing the equipment necessary to fulfill those requirements. The provisioning of wireless equipment is dependent upon the characteristics of the target market that will utilize the wireless equipment. The characteristics of the target market are used to predict the wireless requirements of the wireless communications networks likely to be installed in the target market. Two preferred embodiments are disclosed herein.

In the first embodiment, the wireless requirements to be predicted define the equipment necessary to implement a complete installation package for a wireless communication network for the most likely locations characteristics (e.g., building size and construction materials) found in the target market, and the most likely set of wireless features (i.e., activities) required by a particular target market.

In the second embodiment, the equipment currently in stock in a vendor's inventory, or the equipment that can be readily procured, is known. In this case, the wireless requirements to be predicted define the location characteristics into which a wireless communication network can be installed, and the wireless features that can be provided, based on the available equipment.

Hence, it will be apparent to one skilled in the art that the same general steps are being used in both cases, the order of the steps being modified, and that the steps in the method could be applied to the prediction of other variable aspects of wireless network design and inventory management.

It is convenient for the purposes of this description to reference an embodiment of the current invention as it is applied to a wireless communication network installed at a location (typically, inside a building or other structure). It is understood, however, that the term “building construction” is defined as including, but not limited to, the building materials used in the construction of a building, the floor plan design of the building, the ceiling height and room size, and other measurable characteristics of a building and also the characteristics of an outdoor location into which a wireless communication system may be installed, including, but not limited to, elevation and terrain features, foliage and landscaping features, buildings, obstructions, and objects present in the outdoor location. The present method may, therefore, be applied to either indoor or outdoor sites.

Wireless networking equipment includes radio transmitter/receiver base station devices with associated antennae components, the combined base station and antenna unit referred to as an “access point”. Access points are used in the implementation of a type of wireless communication system generally known as a wireless Ethernet Local Area Network (WLAN). The radio transmitter/receiver base station devices and associated antennae used for cellular telephony are referred to using different terminology, but the radio wave propagation issues related to the design of a wireless communication system for WLAN, radio telephony, or other purpose are identical. In every case the construction characteristics of the installation location have an effect on the transmission and reception of the radio signal. If the equipment installed to implement a wireless communication system is not properly specified, or if it is installed in an incorrect location, the communication capabilities of devices attempting to use the wireless communication system will be impaired. One skilled in the art will recognize that while the description of the present invention refers to WLAN implementations with access points, the invention could be applied to any radio communication system wherein transmitter and receiver equipment was specified to meet the communication requirements of a particular sales market.

First Preferred Embodiment: Predicting Complete Installation Packages

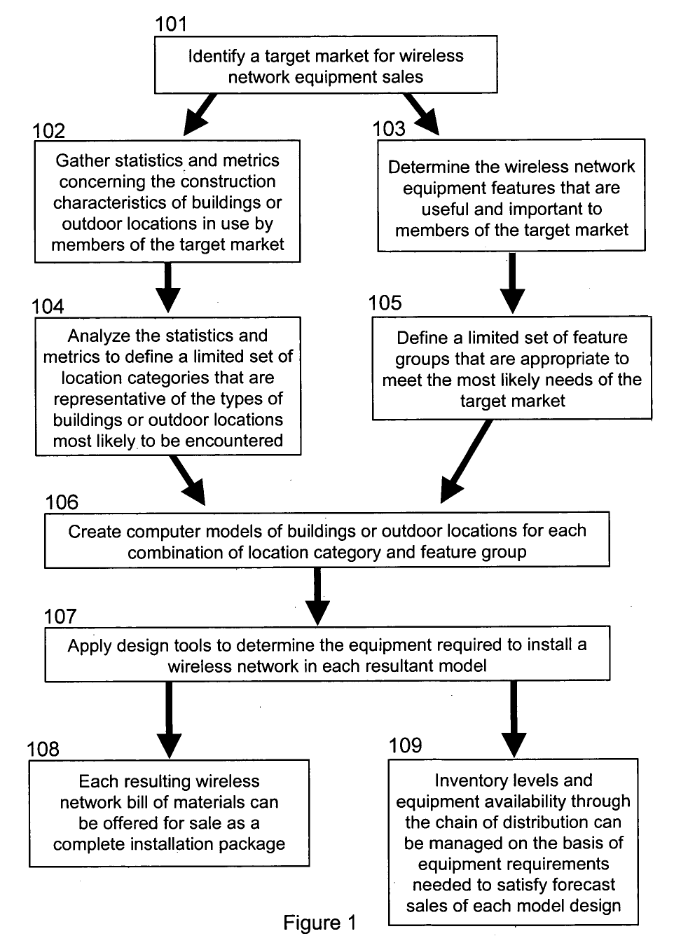

Referring now to FIG. 1, there is shown a flowchart depicting the first aforementioned variable aspect of the invention wherein the variable to be predicted defines the equipment necessary to implement a wireless communication network for the most likely categories of building construction found in, and the most likely set of features required by, a particular target sales market. The result of the prediction process will be the creation of one or more complete equipment packages (step 108) and determination of equipment requirement counts (step 109) allowing a confirmation that appropriate inventory levels are available for satisfying sales of the equipment packages as determined in step 108.

As shown in FIG. 1, an equipment manufacturer or resale vendor focuses their sales efforts by identifying one or more specific target sales markets (step 101). The target markets into which sales penetration is desired are determined by the equipment seller and may be broad in scope, or may be tightly constrained (“vertical markets”).

Information is available describing the types of locations (i.e., buildings, structures or outdoor areas) utilized by members of a particular target sales market. Statistics and metrics describing the characteristics of the locations are gathered (step 102) typically from available public sources although these types of statistics and metrics could be obtained from private sources or through direct, empirical measurement. The statistics and metrics are evaluated so as to determine the construction characteristics of the buildings, structures, or outdoor locations used by the target market (step 104), as will be described in detail next. The statistics and metrics are analyzed to define a limited set of location categories that are representative of the types of buildings, structures, or outdoor locations in a particular target market (step 104).

As with the locations, information is required in regard to the types of wireless activities that are useful and important to the members of the target market. Based upon the target market identified in step 101, the wireless activities (i.e., features) having utility to the target market are determined (step 103). Examples of wireless activities include voice-over-IP, email, Internet access, streaming audio, streaming video, RFID-backhaul, and general file transfer. Features having utility to the target market are described here in terms of digital data networking, however it will be obvious to one skilled in the art that features could be based on analog radio communication systems. Examples of analog systems include radio paging, “walkie-talkie” systems, medical patient telemetry, and remote control. The wireless activities determined in step 103 are then grouped into activity sets that are divided based upon wireless requirements such as data rate and latency (step 105). For example, a premium activity set will accommodate and thus include most wireless activities such as low data rate activities like voice-over-IP and high data rate activities such as streaming video and general file transfer. In contrast, a basic activity set will accommodate and thus include only low data rate activities such as voice-over-IP and email. Ultimately, premium activity sets will require higher quality and perhaps a greater amount of wireless equipment (which in turn means higher cost), than more basic activity sets. The output of step 105 is a number of activity sets designed to give the target market a variety of wireless equipment packages to choose from when constructing a wireless communication network.

Once the location categories and wireless activity sets are defined (steps 104 and 105, respectively), initial computer models are created for each location category and for the types of radio equipment that may be applicable to the wireless activity sets (step 106). The initial computer models related to the building or outdoors location include floor plans representing the 3-dimensional space described for the location category and the RF characteristics of the obstructions and partitions in the space. The RF characteristics include, for example, signal attenuation, signal reflectivity, signal absorption, and other measurable characteristics that may affect the propagation or strength of an RF signal in the space. Additionally, computer models are created to represent the types of radio equipment that may be applicable to servicing the requirements of the wireless activity sets. These models are available for determining the specific equipment requirements and installation locations in the next step (step 107). The number of different resultant models from step 107 is equal to the number of location categories multiplied by the number of wireless activity sets.

Computer design tools are applied to the initial computer models to determine the wireless equipment required to install a wireless network in each location category and for each wireless activity set (step 107). The applicable radio equipment (identified in the initial computer models created in step 106) is placed into the simulation of the space (also created in step 106) and an experienced RF engineer determines the placement of equipment necessary to meet or exceed the requirements of each activity set.

The resultant models generated in step 107 (consisting of specific equipment to meet the requirements for specific activity sets in specific location categories) are then used to create a wireless network bill-of-materials for each resultant model (step 108). At the completion of step 108 the designs can be offered for sale into the target market identified in step 101. Additionally, inventory levels and equipment availability through the chain of distribution can be managed based on equipment requirements to satisfy forecast sales of each resultant model (step 109).

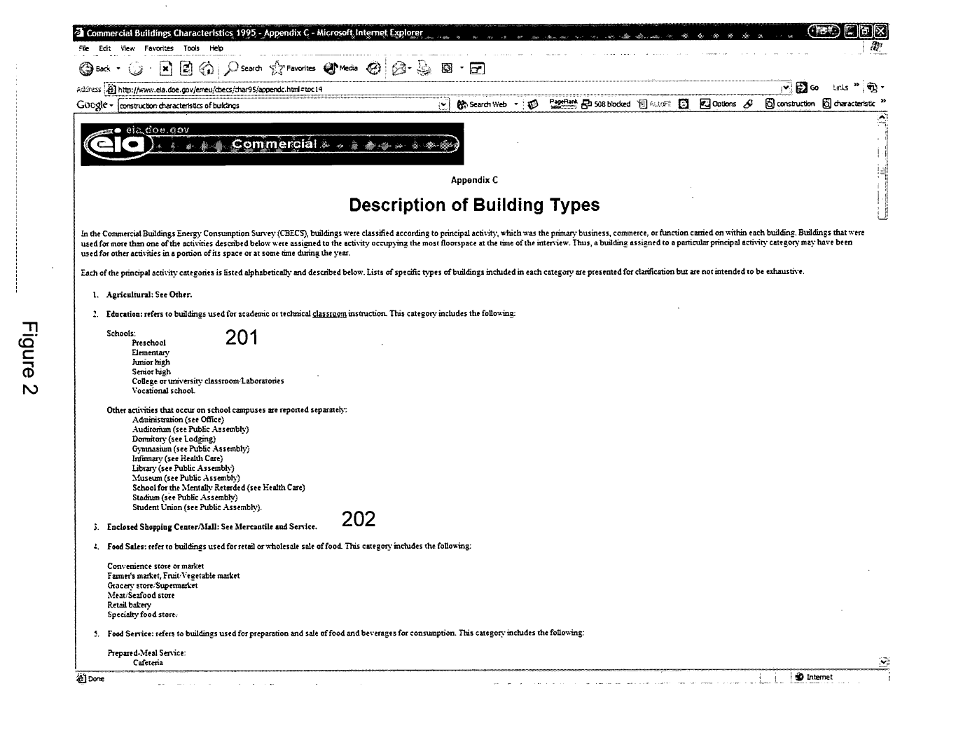

The details of the various steps of the method depicted in FIG. 1 are described below. As previously described, in step 102 statistics and metrics regarding location characteristics are gathered. FIG. 2 depicts an exemplary publicly accessible web site on the World Wide Web from which such statistics and metrics can be gathered. In particular, FIG. 2 shows a publicly accessible web page on the U.S. Department of Energy web site presenting descriptions of buildings classified according to principle activity, primary business, and function carried on within each building. This is an example of a type of web site at which statistics and metrics concerning the size, floor plan layout, construction, and occupancy of buildings in use by various groups can be found. Information is available for target markets such as schools 201 and enclosed shopping centers 202.

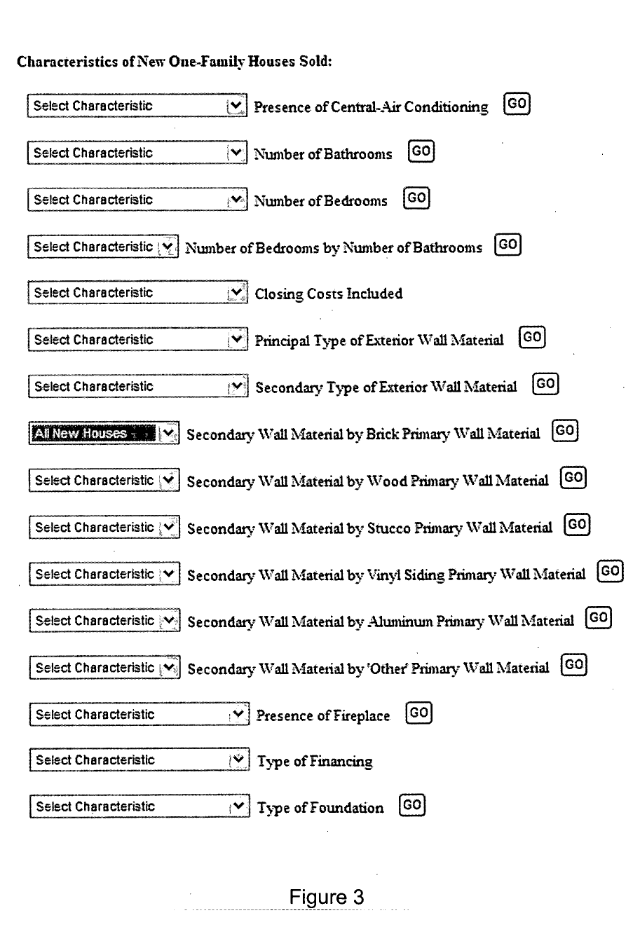

Another example of a source for statistics and metrics is shown in FIG. 3, it can be seen that searching for statistics and metrics concerning buildings, structures, or outdoor locations is facilitated through the use of search query forms, available to the public on the World Wide Web. In particular, FIG. 3 shows a publicly accessible interactive web form on the U.S. Census Bureau web site through which the types of construction materials used in buildings can be queried based on various criteria. FIG. 3 allows a search for the type of construction materials in use in particular buildings. As was explained relative to FIG. 2, this is only one small example of a large number of similar information sources that are publicly available.

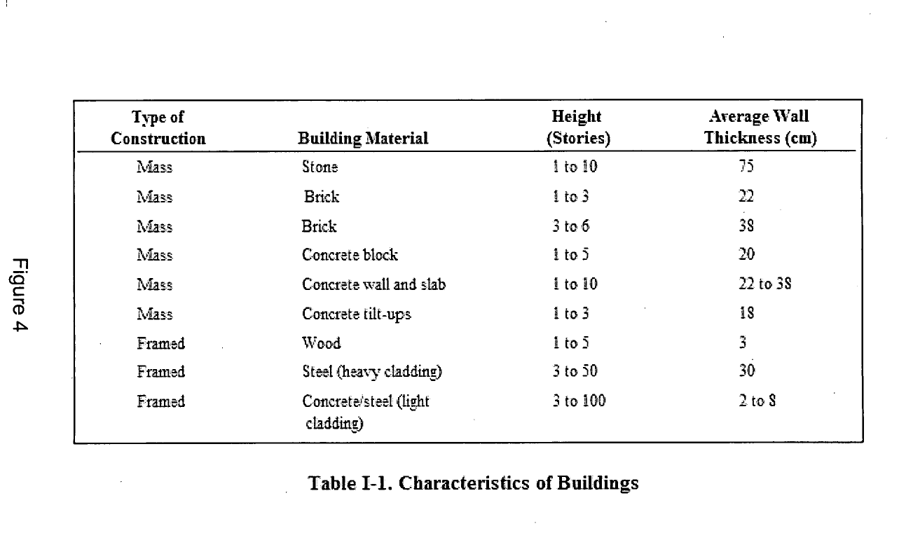

Referring now to FIG. 4, another example of publicly available information found on the World Wide Web is depicted, in this case providing detailed average construction characteristics for buildings of various types and sizes. In particular, FIG. 4 shows a table from a publicly accessible web site (tpub.com) by Integrated Publishing of Spring, Tex. presenting specific average construction characteristics for various types of building materials. This figure demonstrates that statistics and metrics required for the categorization described in step 104 are readily and freely obtained.

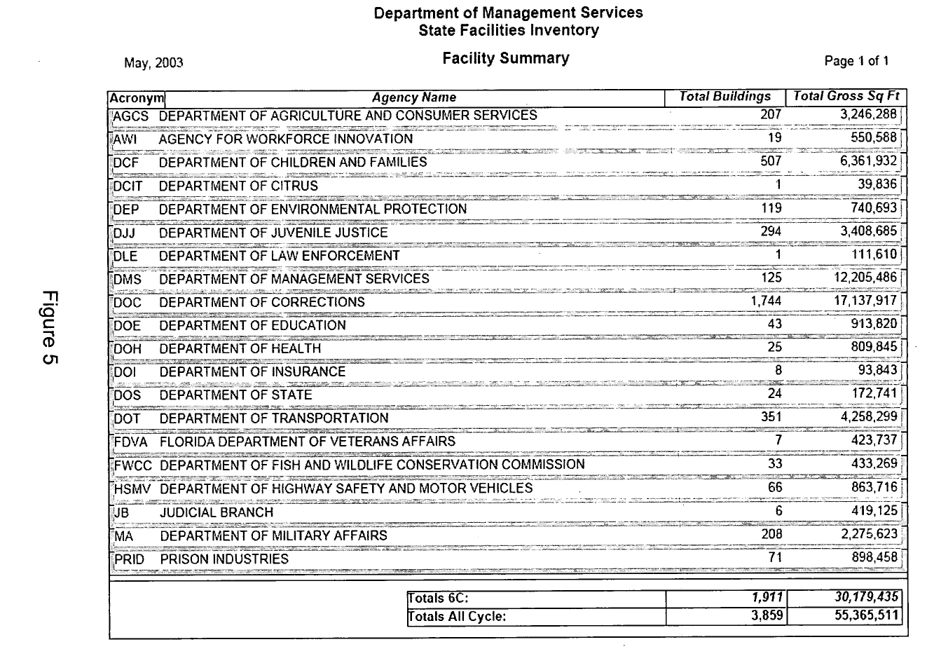

Referring now to FIG. 5, a state-specific list of government buildings is depicted, along with statistics and metrics related to their construction. In particular, FIG. 5 shows a report publicly accessible on the Internet that shows the size (in square feet) for buildings in use by various government agencies. The table shows the size (in square feet) and facility use for buildings constructed in the State of Florida. This figure is presented to again emphasize that statistics and metrics required for the categorization described in step 104 could be obtained readily and freely.

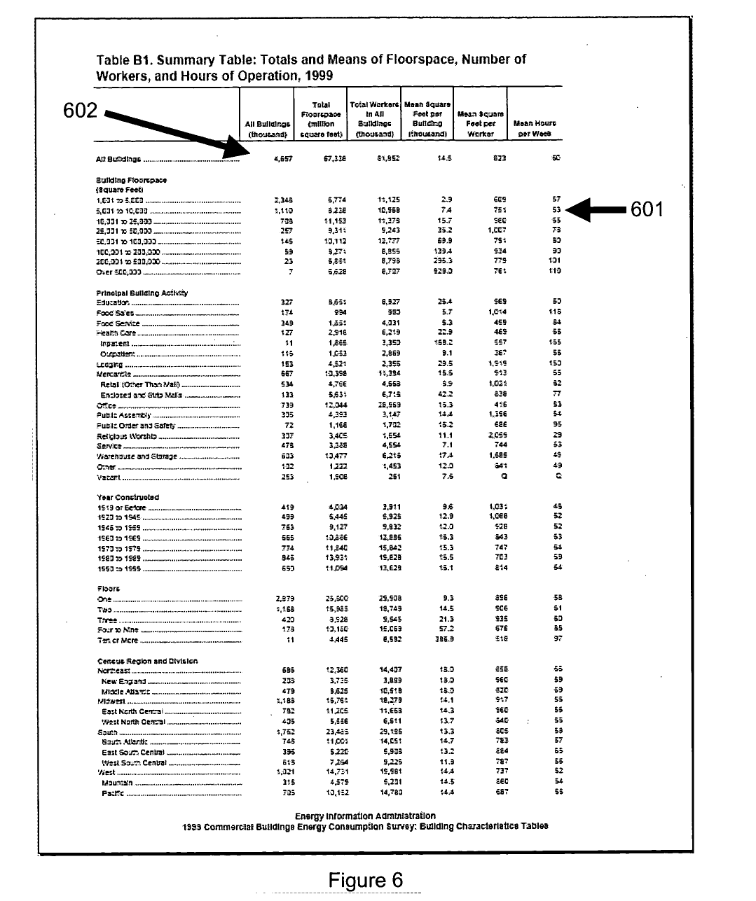

Referring now to FIG. 6, we see a table taken from a lengthy report, available on the World Wide Web, created by the United States Census Bureau, in which buildings are categorized based on size, and average area allocated to each occupant. Additionally, this report details the number of floors in buildings and is divided geographically for different areas in the United States.

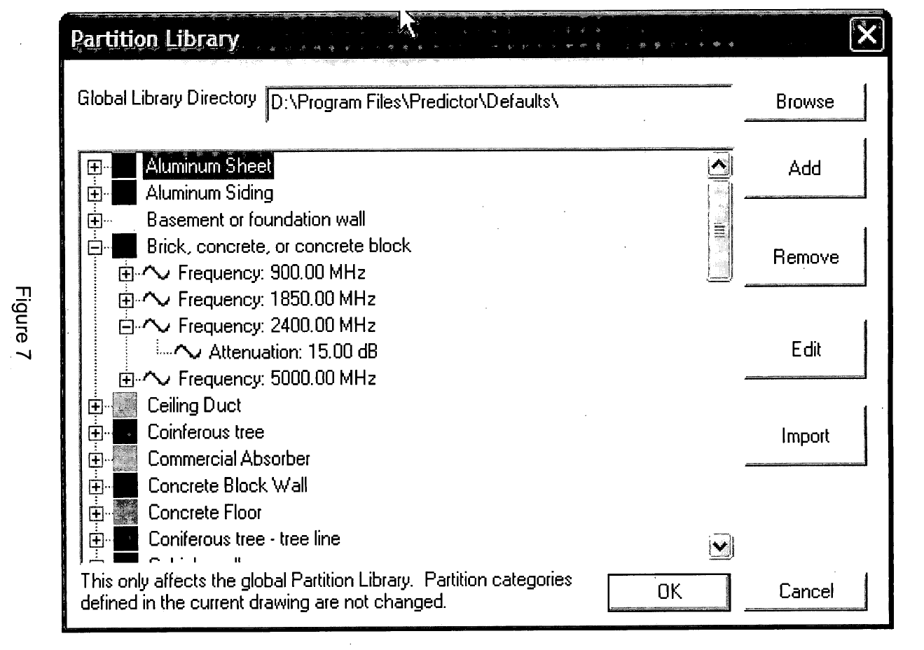

Other useful statistics and metrics include general categorization of partitions and obstructions based on their effect on RF signals. By way of example, FIG. 7 shows a screen image from an RF design software program known as “LAN Planner” from Wireless Valley, Inc. (Austin, Tex.). This is another example of statistics and metrics readily available to those skilled in the art.

The preceding examples demonstrate that statistics and metrics regarding the construction of buildings, structures, and outdoor locations can be obtained easily on the World Wide Web. Although examples are not provided for every situation, it should be evident that it is possible to gather statistics and metrics making possible the categorization specified in step 104.

As previously discussed with respect to FIG. 1, once a target sales market is identified (step 101), statistics and metrics were gathered from available sources, such as the examples shown in FIGS. 2-6, describing the construction of buildings, structures, or outdoors locations in use by the target market (step 102). The gathered statistics and metrics are used to group (step 104) the buildings, structures, or outdoor locations into a limited set of categories, each category having characteristics, which will have a similar effect on the transmission of radio signals in the location. The categorizing of step 104 is done using direct observation, statistical analysis, and the experience typical of one skilled in the art to distill the statistics and metrics concerning the buildings, structures, and locations into categories

As an example of location categorizing, consider in detail the table shown in FIG. 6. Assume for the purposes of this example that a manufacturer or equipment vendor sells to a business market across the United States. Examination of the line of statistical information for buildings with 5,001 to 10,000 square feet (line 601) shows that the mean size of a building in this size range is 7,400 square feet. The statistical information, for this example, ultimately is used to predict the equipment requirements and inventory levels necessary to provide equipment to this segment of the target market (steps 108 and 109).

Continuing with the example, an area of 751 square feet is used for each worker (line 601). Hence, it can be determined by simple division that buildings with 5,001 to 10,000 square feet have, on average, between 6 and 14 workers. Thus, it will be necessary to install wireless network equipment that will support at least 14 users. One skilled in the art can calculate the data transfer requirements necessary to support 14 users based on the type of activity these users will be performing as typical users in the target market. Moreover, the defined category can also include the definition of the type of activity supported by members of the target market who fall into the category. Whether or not construction and use characteristics are used together to define a category, or separately to create construction categories and separate use categories is left to the discretion of the RF designer employing the present method.

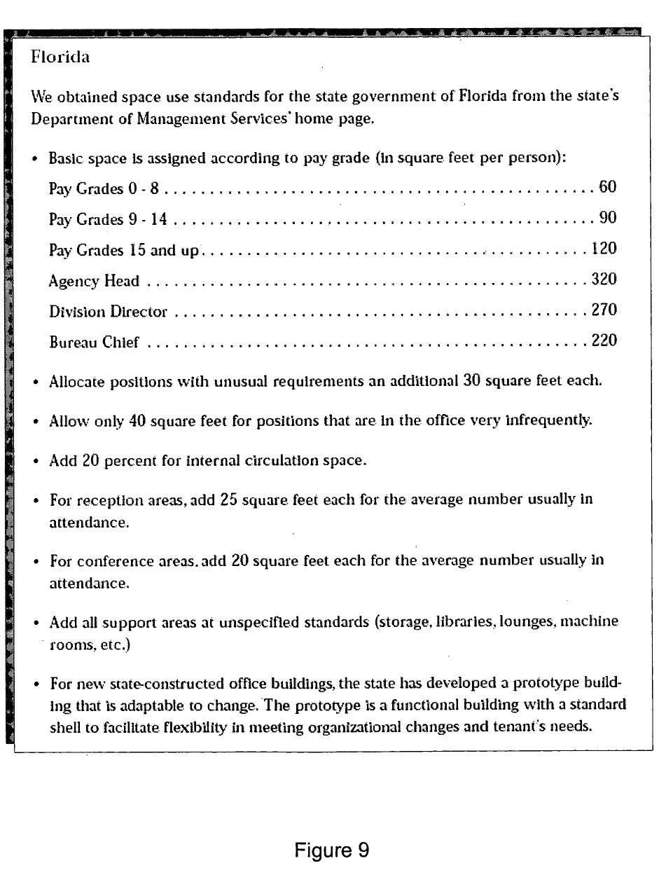

Referring to FIG. 9, statistics regarding the office sizes in use in the State of Florida are provided in a readily available on-line U.S. Census Bureau report. A worker in Pay Grade 0-8 (in the state of Florida) is allocated a 60 square-foot work area, and Pay Grade 9-14 gets a 90 square foot area. Information of this nature is either available, or can be calculated, for any type of building, in any type of vertical sales market, in any state or other defined location. Information of this type is used to determine the average, or typical, size office area as per the location category definitions being created in step 104.

Turning to step 103, the features and capabilities required by the end users of the wireless network are now determined based on the types of activities being performed by the user community. These activities might include file transfer, Internet browsing, email, Voice-over-IP network telephony, or any other application being implemented with wireless network connectivity.

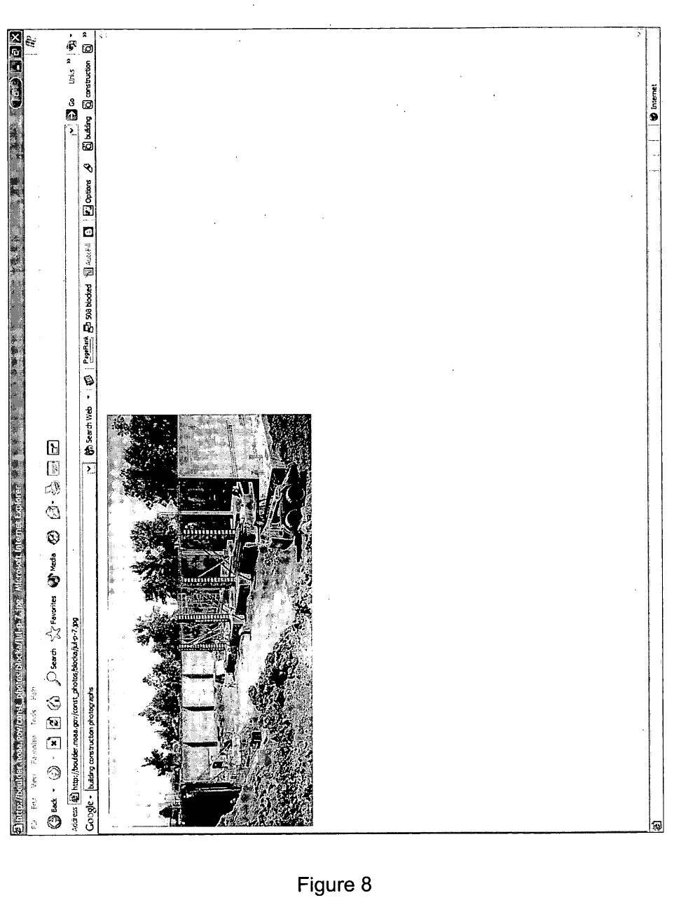

Returning now to FIG. 7, one skilled in the art would be able to determine, to a reasonable degree of accuracy, the construction materials used in the buildings in the target market. This would include reference to the statistics and metrics previously gathered as well as to pictures of representative buildings, structures, outdoor locations, and particularly, with reference to photographs of construction available on the World Wide Web, an example of such photograph is shown in FIG. 8, which is a screen image from the World Wide Web showing a building under construction. The RF engineer evaluating the building construction, being skilled in the art and through consultation with building architects, contractors, owners, or others, would be able to classify each partition in the building as to its effect on RF signal propagation. The RF signal propagation effects for most building materials are well known to those skilled in the art and unusual materials can be measured and evaluated empirically.

With reference to function block 104 in FIG. 1, and in the context of the example being developed in this discussion, it can be seen that one might create the following categories:
Category 1: Buildings 5,001 to 10,000 square feet, cubicle areas
Category 2: Buildings 5,001 to 10,000 square feet, drywall partitions
Category 3: Buildings 5,001 to 10,000 square feet, concrete walls

Based on the vast amount of readily available construction statistics and metrics, any number of location categories can be created for all types of buildings, structures, or outdoor locations.

From the activities determined in step 103, a limited set (of, but not limited to, approximately three or four) of feature groups are defined (step 105). Each feature group serves as a distinct wireless activity package applicable to the target sales market, where each wireless activity package contains different wireless activities than the other. This enables customers to choose from a variety of wireless activity packages depending on budget and the usage requirements (such as data transfer rate, packet latency, security and performance monitoring, and the like) for the wireless network applications desired.

By way of example, the following feature groups can be created based upon usage requirements:
General File Transfer: Up to 1 Megabit/second per user
Email and Internet: Up to 384 Kilobits/second per user
Voice-over-IP Telephony: Up to 8 Kilobits/second per user with latency of less than 5 milliseconds

The greater the data transfer rate required, the greater the number of wireless activities that are available. In other words, the wireless activity package with the usage requirements includes all wireless activities that require those usage requirements or less. In the example provided above, the 1 Megabit package includes general file transfer as a wireless activity, as well as email, Internet and Voice-over-IP telephony. The package with the lowest data transfer rate includes only Voice-over-IP telephony. Any number of feature groups can be created based a variety of usage requirements.

In steps 101, 102, 103, 104, and 105, the types of buildings that will be encountered in a particular sales market including the construction types and office sizes in these buildings, as well as useful wireless activity packages have been ascertained with reasonable accuracy for the target sales market. This information is used in steps 106, 107, 108, and 109 to predict the design requirements for any given wireless network installed in the target market.

By way of example, as shown in FIG. 6 at line 601, 1,110,000 buildings in this size range were tabulated out of a total (line 602) of 4,657,000 buildings. Hence, by division, it can be seen that 24% of all buildings in the sample fall into this range. Based on this assessment alone, 24% of all sales will fall into this range. Therefore, when an equipment list is specified for the location category being defined, 24% of the inventory turnover will be attributable to sales into the defined location category in the target sales market.

Once the location categories (step 104) and activity sets (step 105) are defined, equipment specifications need to be determined that will meet or exceed the data transfer rate, packet latency, and any other criteria established in the usage requirements of the activity sets/feature groups.

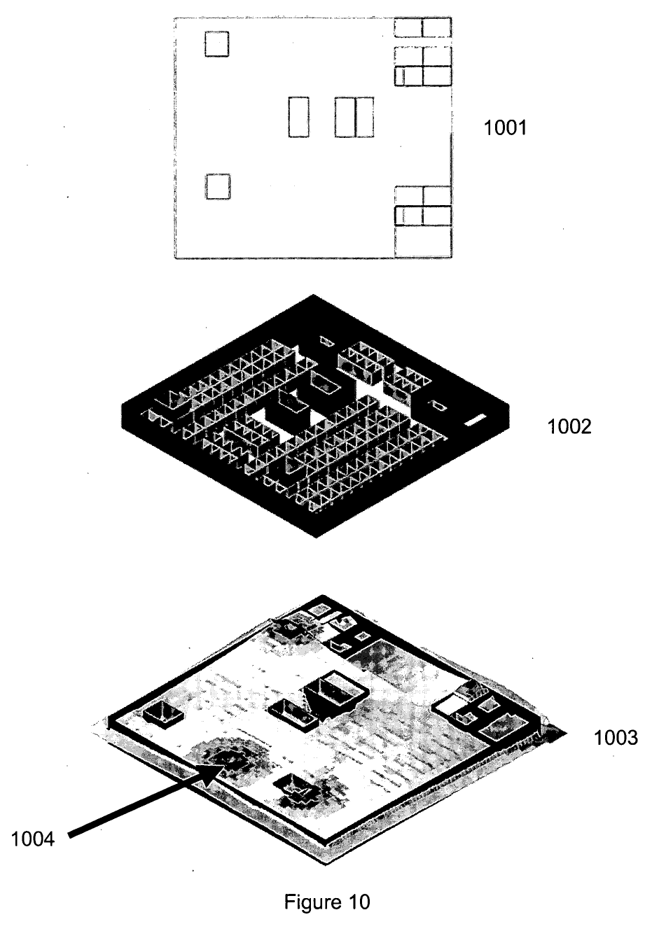

Referring to step 106, the previously ascertained characteristics are used to construct initial computer models of the buildings in each previously ascertained location category. FIG. 10 shows examples of computer models that represent various aspects of the modeling process. The RF engineer employing the present method begins with a basic floor plan 1001 and creates a 3-dimensional model 1002 of the space in which the RF characteristics of the partitions and obstructions have been specified. An initial computer model 1002 is created for the floor plan for each location category, and the models 1002 will become the basis for one or more final plans 1003 generated in step 107 that will include the equipment necessary to meet or exceed the requirements of each wireless activity set/feature group.

In step 107, an RF design engineer uses computer design tools to perform a “what if” analysis on the initial computer models 1002 determined in step 106 to determine the wireless equipment required to install a wireless network in the space. This step yields a final design 1003 for each location category and wireless activity set. The number of different resultant final designs 1003 is equal to the number of location categories multiplied by the number of wireless activity sets. Referring to FIG. 10, final design 1003 shows an example of a resultant model, with wireless signal coverage depicted as a graphic “fill” inside the previously constructed building model 1002.

FIG. 10, as described above, depicts the stages of creation of the resultant computer models in steps 106 and 107, using by way of example, the Wireless Valley LAN Planner (TM) software previously discussed with respect to FIG. 7. Basic floor plan 1001 is a floor plan before the RF designer processes it, initial computer model 1002 is the formatted 3-dimensional model generated in step 106, and resultant design 1003 includes the equipment placement at the conclusion of step 107. Equipment 1004 is shown within resultant design 1003.

By way of example, in step 106, a two-dimensional floor plan 1001 is created (based on the specifications for the “typical” building within the location category), which is for example a floor plan for a 10,000 square foot, category 2 building with 90 square foot offices. Any building, of any size, and with offices or other interior partitions of any type could be modeled. Then, the two-dimensional floor plan 1001 is converted into a three-dimensional floor plan 1002. The RF engineer doing the modeling uses the metrics related to building construction to determine the correct heights and partition types to include in the model. Finally, the wireless base stations and antenna equipment 1004 are added to three-dimensional floor plan 1002 to create a simulated office (i.e., resultant design) 1003 predicting RF coverage to show how the RF signals will cover the simulated office building. This modeling is performed for each location category.

In step 107, the RF design engineer places an appropriate number of wireless base stations and antennas in the simulated space to meet the design objectives for usability and coverage within the size and category of space for each feature group. This is performed for each feature group applied to each initial model created in step 106 and produces a resultant design 1003 as depicted in FIG. 10.

A specific bill-of-materials is generated (step 108) for each -resulting wireless network design from step 107 that can be offered for sale as a complete installation package. Additionally, the chain of distribution can be managed since the relative number of buildings of each category in each vertical market is known, and, consequently, the correct inventory levels can be maintained at the manufacturer or reseller (step 109).

This first embodiment of the present invention is a unique approach to anticipating sales opportunities and the associated wireless network designs and bill-of-materials needed to satisfy those designs. Additionally, the first embodiment of the present invention provides a way to reduce inventory costs by avoiding stocking of unneeded items or overstocking needful ones. It also facilitates the sales process for the reseller or manufacturer as well as for the consumer. The reseller/manufacturer can have the right equipment on the shelf, ready to satisfy a customer requirement, and thereby improve the sales process. The consumer can receive a speedy, accurate price quotation based on building size, construction category, and type of network use, and be assured that the equipment necessary to satisfy their order will be readily available.

As described above, the first preferred embodiment provides a method whereby statistics concerning the construction of buildings or the characteristics of outdoor areas used in particular sales markets may be categorized in such a way that computer models can be constructed to represent the most typical wireless network implementation scenarios and thereby predict the equipment required to implement wireless networks for customers in those markets.

Second Preferred Embodiment: Predicting Consumer Options Based On Existing Inventory Levels

In the second embodiment, the equipment currently in stock in a vendor's inventory, or the equipment that can be readily procured, is known. In this case, the variables to be predicted define the categories of building construction into which a wireless communication network can be installed, and the features that can be provided, based on the available equipment.

It will be apparent that the same general steps and procedures described for the first embodiment of the present invention are being used in this second embodiment as well, the order of the steps being modified, and the relationships between the steps being adjusted.

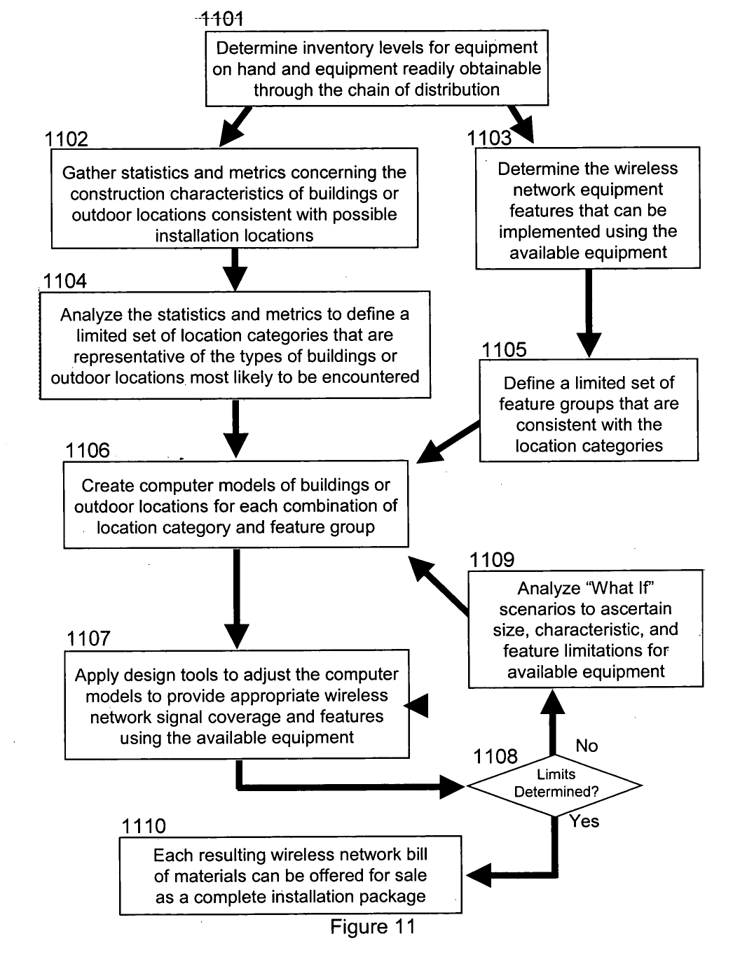

As depicted in FIG. 11, in the second preferred embodiment, it is first necessary to determine the equipment available for implementing a wireless network (step 1101). The features that can be implemented using the available equipment are identified (step 1103) in a manner similar to step 103. Step 1103 differs from step 103 in that the features are determined based upon the available equipment rather than the target market. Then, from the identified features, limited sets of features are defined to form feature groups (i.e., wireless activity sets) consistent with the likely needs for the location categories identified in step 1104 (step 1105) in a manner similar to step 105. Step 1105 differs from step 105 in that the feature groups are defined based upon the location categories generally rather than the likely needs of the target market. As in the first preferred embodiment, building statistics are gathered (step 1102) and analyzed (step 1104) in a similar manner as step 102 and step 104, respectively. However, steps 1102 and 1104 differ from steps 102 and 104, respectively, in that the statistics and metrics are gathered and further analyzed based upon a general consideration of possible installation locations rather than a more limited target market.

Having completed the building categorization (steps 1102 and 1104) and the definition of feature groups (steps 1103 and 1105), the RF design engineer begins to construct a model of a building in which proper RF signal coverage may be obtained using the available equipment, and providing the available features (step 1106 and 1107). The RF engineer continues to modify the model, gradually increasing the size of the building, modifying the RF signal propagation characteristics of the building partitions, or modifying other parameters until a model has been created that exceeds the ability to meet the bill-of-materials and features required by the model from the existing inventory (step 1108).

Next, the RF engineer adjusts the model using “what if” scenarios to bring it into agreement with the available inventory and providing modifications to the model to represent various types of buildings and/or feature sets that can be built from stock (step 1109). This results in a reiterative process through steps 1106, 1107, 1108 and 1109.

Ultimately a set of possible wireless network configurations can be defined (step 1110), each of which can be built from the existing inventory.

This second embodiment of the present invention provides a way to maximize the usability of available equipment inventory by the wireless networking reseller or manufacturer. Because a determination can be made as to the most likely types of buildings and applications to be served by the available stock, the sales force of the manufacturer or reseller can target specific sales markets that would most likely purchase the in-stock equipment. In this way the reseller or manufacturer can increase the rate at which equipment moves through their warehouse and, thereby, minimize storage costs, carrying charges, or other costs related to the stocking phase of the distribution chain.

Consumers, too, benefit from this second preferred embodiment in that they are presented with immediately available purchase options which may, at the discretion of the reseller or manufacturer, be sold at a discount since the equipment may be that which remains in inventory for long periods of time, or which, for some other reason, is identified by the manufacturer or reseller as equipment that should be discounted. Once so identified, the potential target sales markets into which this equipment can be packaged and sold can be reasonably predicted.

The second embodiment of the present invention allows a prediction to be made as to what types of buildings, and hence, what types of target sales markets, will best benefit from in-stock equipment.

By way of comparison, in the first embodiment the building size and activity sets are known information. The variable is the equipment and its placement within the initial computer model 1002. Applying this embodiment involves placing the first piece of equipment 1004 in one part of the building then adding another and another until the entire floor area (or outdoor area) is covered.

In the second embodiment, the available equipment is the known information and the activity sets are assumed, but the size of the building needs to be determined to create the location categories. This is accomplished by making a “best guess” at a starting building size and then placing equipment into it (first iteration through steps 1106 and 1107). After this is done, the size of the building is increased to determine the next “step” in size at which an additional radio (access point) will be required (steps 1108 and 1109). This “what if” step is not found in the first embodiment.

In both the first and second embodiments, there is an underlying “what-if” step that is inherent in the step during which equipment is placed into a floor plan (step 107 and step 1107, respectively). This placement “what-if” is the process by which the designer places a radio, and then moves it around (i.e., “what if” it is over here, “what if” it is over there?) to determine the correct installation location. This placement “what-if” is part of applying RF design skills by the RF designer in steps 107 and 1107. The act of designing involves this type of placement “what-if” in both embodiments. The second embodiment requires a second “what-if” step since the building size is fixed in the first embodiment but not in the second.

From the above description, it will be apparent that the invention disclosed herein provides a novel and advantageous apparatus and method for predicting design requirements for wireless networks. The foregoing discussion discloses and describes merely exemplary methods and embodiments of the present invention. One skilled in the art will readily recognize from such discussion that various changes, modifications and variations may be made therein without departing from the spirit and scope of the invention.

1. A method for determining equipment requirements for a wireless communication network, said method comprising the steps of:
determining current inventory of wireless equipment;
defining a set of equipment features capable of being implemented with the current inventory;
obtaining representative location information describing construction characteristics of locations for installation of the wireless network;
defining a plurality of location categories, wherein each of the location categories is representative of locations with similar construction characteristics based on the representative location information;
defining at least one feature group comprising a subset of the set of equipment features, wherein the feature group has utility for the location categories; and
determining the wireless equipment for constructing the wireless communications network for at least one of the location categories based upon the similar construction characteristics and the feature group.

2. The method of claim 1, wherein the wireless equipment includes at least one of radio transmitter/receiver base station devices and antennae components.

3. The method of claim 1, wherein the representative location information for indoor locations includes at least one of building materials, floor plan design, ceiling height and room size.

4. The method of claim 1, wherein the representative location information for outdoor locations includes at least one of elevation and terrain features, foliage and landscaping features, buildings, obstructions, and objects.

5. The method of claim 1, wherein the set of equipment features includes at least one of digital data transfer, file transfer, email, world wide web browsing, voice-over-IP network telephony, analog radio communication, telemetry, and remote control.

6. The method of claim 1, wherein the wireless equipment determining step utilizes RF modeling and simulation in generating the bill-of-materials.

7. The method of claim 1, further comprising the step of:
determining usage categories for the equipment features;
wherein the usage categories have associated minimal usage criteria.

8. The method of claim 7, wherein the wireless equipment determining step determines the wireless equipment such that the wireless equipment at least meets the minimal usage criteria.

9. The method of claim 1, wherein RF signal propagation effects differ in the location categories based upon the construction characteristics.

10. The method of claim 1 further comprising the step of: constructing a computer model of the locations based upon the location categories and equipment feature groups.

11. A method for determining equipment requirements in a wireless communication network based upon current inventory of wireless equipment, said method comprising the steps of:
determining a plurality of wireless activities capable of being implemented with the current inventory;
defining a plurality of wireless activity packages, wherein each of the wireless activity packages provides a corresponding group of the wireless activities and differs in amount of the wireless activities in the corresponding group;
selecting performance requirements for each wireless activity in the subset of wireless activities;
identifying a plurality of representative location categories for installation of the wireless network;
obtaining location characteristics for the plurality of representative location categories, wherein the location characteristics include construction characteristics and occupancy usage characteristics;
determining the wireless equipment for constructing the wireless communications network for at least one of the representative location categories based upon the location characteristics and the performance requirements.

12. The method of claim 11, wherein the performance requirements include at least data transfer rate requirements.

13. The method of claim 11, wherein the construction characteristics for indoor locations includes at least one of building materials, floor plan design, ceiling height and room size.

14. The method of claim 11, wherein the construction characteristics for outdoor locations includes at least one of elevation and terrain features, foliage and landscaping features, buildings, obstructions, and objects.

15. The method of claim 11, wherein the plurality of wireless activities includes at least one of file transfer, email, world wide web browsing, voice-over-IP network telephony, analog radio communication, telemetry, and remote control.

16. The method of claim 11, wherein the wireless equipment determining step utilizes RF modeling and simulation in generating the bill-of-materials.

17. The method of claim 16, wherein the wireless equipment determining step determines the wireless equipment such that the wireless equipment at least meets the performance requirements for each wireless activity in the subset of wireless activities.

18. The method of claim 11, wherein RF signal propagation effects differ in the representative location categories based upon the construction characteristics.

19. The method of claim 11 further comprising the step of:
constructing a computer model of at least of the representative location categories based upon the location characteristics and the performance requirements for each wireless activity in the subset of wireless activities.
